(19) United States
(12) Patent Application Publication
(10) Pub. No.: US 2002/0163998 A1
(43) Pub. Date: Nov. 7, 2002

(54) Crisis control system and method

(76) Inventors: Mary Jane Mudd, Houston, TX (US); Tony Shelton, Houston, TX (US)

Correspondence Address: THE MATTHEWS FRIM, 1900 West Loop South, Suite 1800, Houston, TX, 77027, US

(21) Appl. No.: 09/850,460

(22) Filed: May 7, 2001

(51) Int. Cl. H04M 11/04

(52) U.S. Cl. 379/37

(57) ABSTRACT

A crisis control system and method is provided for controlling procedures and communications especially for use by a non-emergency business organization. In preparation for a potential crisis, a crisis communication reporting tree is developed with designated sections of the organization to be notified including high and low priority communication flow paths. The crisis communication reporting tree also provides communication flow lines for external parties including governmental emergency organizations, media organizations, customers, and the like. In one embodiment, various types of communication rules are developed including limiting telephone calls to maintain open telephone lines and relying on other forms of communications for quickly sending forms containing emergency related information. In one embodiment, a computer program is utilized which maintains procedures as well as tracks and directs communications.

### BACKGROUND OF THE INVENTION

1. Field of the Invention

The present invention relates generally to control systems and, more particularly to systems and methods for crisis communications and procedures.

2. Description of the Background

A crisis is a highly volatile, dangerous situation requiring immediate remedial action. Despite even comprehensive precautions, specialized equipment, and training programs which may be utilized by a business operation to prevent emergencies, unforseen situations can and do occur. Examples of a crisis may include pipeline failure, an explosion or fire, life-threatening damage, a natural disaster such as a hurricane or flood, environmental damage, workplace violence, and the like. Very often, a crisis comes in the form of a physical emergency, truck accident, or the like that requires immediate attention. While emergency organizations that respond to emergencies on a daily basis have procedures in place, such procedures are generally not applicable for use by general purpose business operations whose day to day business structures is non-emergency based. In general, with respect to a business operation, a crises is any non-routine situation that interferes with normal operations such as an accident that threatens human life, or property, or even a company's reputation and/or profitability.

Typically, a crisis will get worse before it gets better especially without efficient means to provide control over the situation. For instance, crisis handling procedural problems may often arise during a crisis. Another significant problem that occurs in a crisis is that of communication breakdowns. The present application takes benefit from insights of procedural and communication problems based on actual emergencies and provides unique solutions to such problems. The present invention is especially suitable for relatively large business operations whose primary business goals are non-emergency oriented to thereby improve emergency responses and communications between large numbers of employees as well as shareholders, foreign affiliates, governmental service groups such as police and fire agencies, customers, media organizations, and the like. Consequently, there remains a need for a reliable, effective, procedural and communication system and method suitable for handling emergencies and crisis situations. Those skilled in the art have long sought and will appreciate the present invention which provides solutions to these and other problems.

### SUMMARY OF THE INVENTION

The present invention was designed to provide greater control over crisis situations and thereby enhance communications, reliability, speed of operation, personnel and public safety.

Therefore, it is an object of the present invention to provide an improved crisis control system and method.

These and other objects, features, and advantages of the present invention will become apparent from the drawings, the descriptions given herein, and the appended claims.

The present invention provides a method for handling a crisis for a non-emergency organization with a plurality of organization members. The method may generally include one or more steps such as developing a crisis communication reporting tree with designated sections of the non-emergency organization to be notified accordingly, providing the crisis communication reporting tree with designated sections for external sections which are not part of the non-emergency organization, and providing the communications reporting tree with priority flow paths whereby, for instance, alerts for all crisis and alert on an as needed basis are designated and such that the priority flow paths indicate a path of communication between the organization sections. Other steps may include providing that each organization member has two previously designated contacts for originating a crisis report by at least one type of communication means. In one embodiment, the external sections which are not part of the non-emergency organization may include emergency organizations and media organizations.

In some cases, the method may comprise limiting telephone calls from a first crisis reporter to no more or less than two call contacts to be reached wherein the first crisis reporter may be one of the plurality of organization members. Additionally method steps may provide different communication guidelines and flowpaths depending on a type of communication to be utilized.

In one embodiment, steps such as providing a crisis control computer program for the separate computers related to the plurality of organization members may be utilized. In this case, automated steps may include providing a plurality of forms related to responding to a crisis within the crisis control computer program and/or providing one or more previously prepared communication lists for sending one or more of the forms within the crisis control computer program. The previously prepared communication lists may therefore include a primary email group, a secondary email group, a facsimile group, and the like. Preferably information is readily available such as a telephone listing for calls related to a particular computer station in the crisis control computer program. In one embodiment, step by step procedures may be provided in the crisis control computer program. Moreover, the program may be readily available for starting by displaying an emergency button on each of a plurality computer screens for starting the crisis control computer program by a respective organization member.

### BRIEF DESCRIPTION OF THE DRAWINGS

FIG. 1 is a schemmatical view of a communication network or reporting tree prepared prior to a crisis in accord with the present invention; and

FIG. 2 is a schemmatical view disclosing a block diagram for a crisis control computer program that may be operable on employee computers.

While the present invention will be described in connection with presently preferred embodiments, it will be understood that it is not intended to limit the invention to those embodiments. On the contrary, it is intended to cover all alternatives, modifications, and equivalents included within the spirit of the invention.

### DESCRIPTION OF THE PREFERRED EMBODIMENTS

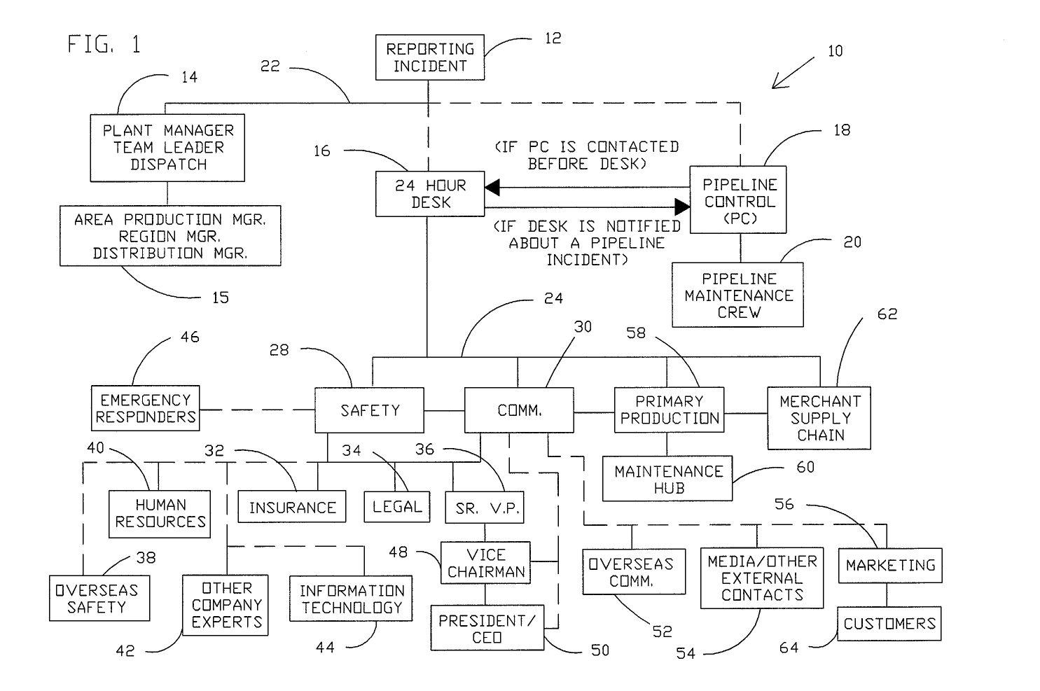

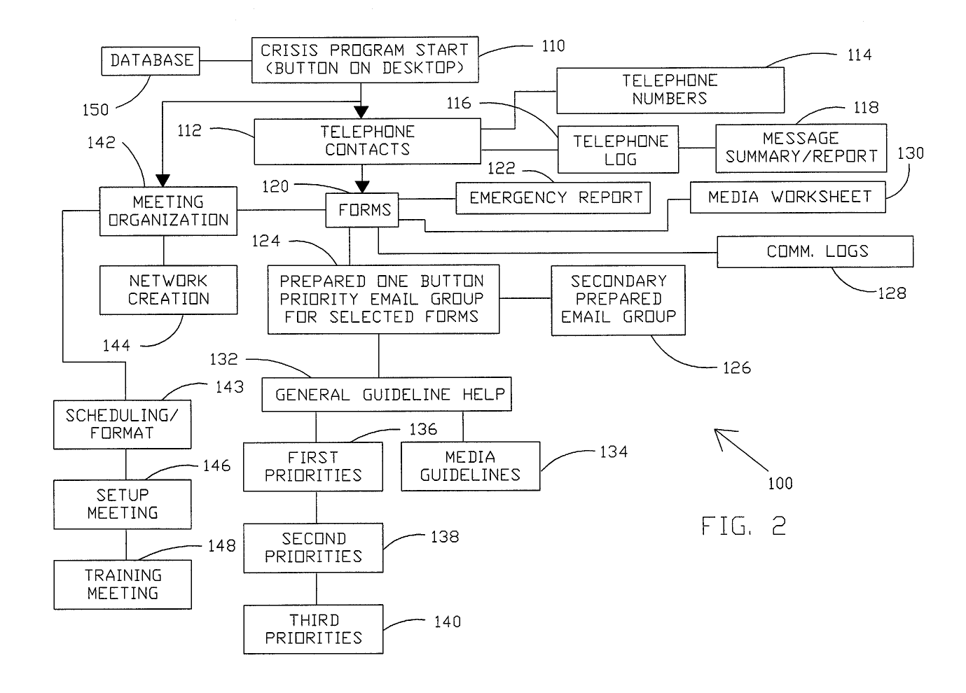

Referring now to the drawings, and more particularly to FIG. 1, there is shown a crisis communication tree or network 10 in accord with the present invention. Efficient, organized communications during a crisis are essential. It will be understood that each organization will require a specific communication tree based on the particular structure of that organization and that communication tree 10 may be representative for a particular organization in accord with the invention. In one preferred embodiment, computer program 100 in FIG. 2 may also be provided to help setting up, maintaining, updating and the like, of a particular communication tree 10 for a particular organization through a series of programmed meetings, training, and the like.

In a presently preferred embodiment, the employee reporting the incident as indicated at 12 is required to contact by telephone or radio or other verbal communication only two previously designated respective organization modules such as, in this case, field crisis contact module 14 and at least one of either 24-hour help desk module 16 or maintenance section module 18. However, in other embodiments the employee reporting the incident at 12 may contact a greater number of respective organization modules. In the present embodiment, a selection of reporting to either module 16 or module 18 is left to the reporting employee 12 and the particulars of the crisis. For instance, for a pipeline crisis, maintenance section 18 which would include a pipeline control monitor in this particular embodiment, would be notified first and would then subsequently notify 24-hour help desk module 16 as well as pipeline maintenance crew 20. In a crisis situation, communication lines, such as telephone, cellular, and radio links, can quickly become overloaded so that in a preferred embodiment, while at least two verbal communications are required, the total number of verbal communications from each person and/or module may be limited to a specified number. For instance, the reporting employee may be limited to two verbal communications such as by radio or telephone. However, some individual discretion as to the number of necessary communications is normally appropriate with awareness that lines are likely to become congested. Other types of communications may be used to supplement information flow by verbal communication as discussed subsequently. It will also be noted that an enlarged view of communication reporting tree may include intermodular connections as may be determined necessary for a particular organization. For instance, the plant manager may have several contacts to make within module 14, and so forth, as well as contacting module 15. The specifics of persons to contact within the modules, telephone numbers, and the like are discussed subsequently. The interconnection lines such as lines 22, 24, and the like, are preferably coded as to the priority of such communications. This coding may be in the form of colors or other distinguishing means such as, for example, dashed and solid lines as indicated in FIG. 1. In the present example, solid lines may indicate a requirement to alert for all crises whereas dashed lines may indicate that alerts should be provided on an “as needed” basis. The communication reporting tree may also be coded by some means as to crisis authority in each module, and if desired, to crisis authority for specific persons. For instance, in the present example, modules and/or individuals within modules marked with an asterisk may have special authority in a crises to convene meetings, dispatch headquarters team, order a company plane, or the like. The particular types of authority may be listed with the detail considered necessary in enlarged views which may be immediately accessible by all employees as discussed subsequently. Crisis team members including modules and/or individuals may also be designated on the network or reporting tree for convenient reference by others in the organization.

In the present example for a particular company, safety module 28 and communications module 30 each have a significant role to play in crisis control. It should be noted that in some cases, it will be known beforehand that communication lines overlap. For instance, both safety module 28 and communications module 30 may each communicate with other modules such as insurance 32, legal 34, senior vice president office 36, overseas safety 38, human resources 40, company experts 42, and information technology 44. In other cases, specific predetermined communication lines are provided such as between safety 28 and emergency responders 46. Likewise, in this particular structure, communication module 30 may communicate on an “as needed” basis with vice chairman office 48, president/CEO 50, overseas communications 52, media organizations and other designated external contacts 54, and marketing 56. Other modules such as primary production 58 may have fewer, but also important, communications directed to maintenance hub 60. Customers and sales may be notified such as through modules 72 and 64, as indicated.

It will be understood that the drawings, such as FIG. 1 and FIG. 2, are intended to describe the concepts of the invention so that the presently preferred embodiments of the invention will be plainly disclosed to one of skill in the art but that the invention may take many forms and is therefore not limited to the particular embodiment disclosed herein. Thus, the drawings may show simplified conceptual views as desired for easier and quicker understanding or explanation of the invention and it will be understood that many modifications and a significant amount of additional detail may typically be involved.

While verbal communications are discussed above, other types of communications may also be utilized. For instance, email and derivatives, as well as fax or teletype may also be utilized and may be organized as discussed below. Additionally, suitable forms may be utilized to help convey and consolidate facts such as emergency reports, media statement guidelines and forms, communication tracking logs, and the like. While one embodiment of the invention may conveniently utilize computers for performing data entry, date/time/place logging, automatic messaging, and the like, it will be understood that computer usage covers only one embodiment of the invention and that manual charts, forms, and the like may also be utilized in accord with the present invention. Moreover, computers may be utilized that depend on the particular environment such as hand held computers, PDA, portable computers, wireless interconnections, desk top computers, networked computers, and the like which usage will depend on the particular organization.

Therefore, referring to FIG. 2, a computer organized program 100 is provided that may be utilized to set up, train, maintain records, store necessary information, and prepare for crisis handling as well as help control procedures and communications. Program 100 therefore also provides a conveniently organized package for transporting the concepts of the invention to other companies/organizations as desired.

Program 100 may be started as indicated at 110. If desired, an appropriate symbol or button may be provided on the computer display (computer desktop) for convenient location and starting of the program. Although the program may be structured in many ways, it is desirable that the particular telephone contacts for any particular employee be provided as indicated at 112 with appropriate names and one or more numbers for each contact as indicated at 114 which may depend on the time of day. In this way, the necessary contacts are immediately available to each employee. Module 116 may be used to automatically or manually log incoming and outgoing calls. A check box may be provided to automatically note time and date if such information is not already automated. Module 118 provides a convenient form to summarize a telephone/radio message while it is still fresh. In some cases, module 118 may also activate a recorder for recording information as desired where appropriate.

During a crisis, various suitable forms for entering data may be provided as indicated at 120. For instance, it will be desirable to produce emergency report 122 which provides information about the emergency or call received about the emergency. This report may include information such as time/date/caller, type of emergency, directions, injuries, hospital, police/fire department notifications, evacuations, etc. If a product is leaking then the type of product, supplier, number of containers, location of leak on a container, present threat, what has been provided and what is needed. Report 122 may then be automatically sent to a previously designated group by email/fax/radio data packets and the like as indicated at 124 for always contact addresses and for an “as needed” contact list as indicated at 126. However, the communication paths may be also be different than those disclosed on reporting tree or network 10 due to the different type of communication means which can essentially be sent instantaneously. Faxes may be also automatically or manually generated. While the information obtained in appropriate forms could be compiled and faxed or otherwise sent by hand, the use of computer system 100 facilitates significant and material information fact flow in an efficient and quick manner. Communication log module 128 may be used to compile and log all or selected communications related to a particular crisis. Other forms may also be provided, such as a media statement worksheet as indicated at 130. The media may be used to communicate with a large number audience and so an organized approach to such communications is highly desirable. Generally a media statement worksheet in accord with the present invention focuses available substantiated facts as may be printed on the data sheet for preparation. The media statement worksheet form may ask factual questions such as when did the event happen (approximate time, date, day of week). However, cautions may be provided in the worksheet to avoid speculation such as concerning cause or the like. The location of the incident and subsequent information such as hospitals where injuries may have occurred is provided. However, names of injured or killed should be withheld at least until the families are notified. A statement may be provided as to the various actions taken by the organization. This may include listing the actions as well as general statements. For instance, in general, statements to the effect of cooperation with police, fire, local, and state authorities may be provided and there may be a check list for such statements that may relate to many crises. In the worksheet, it may desireable to point out certain items to avoid, at least during the initial stages of the crisis, such as discussions which typically involve nonfactual information such as dollar values of damage and the like which, realistically, cannot be determined immediately. If the crisis causes an effect on the community, check boxes and additional lines to fill in may request information on areas or highways closed down, evacuations, whether employees should come to work, how customers will be supplied, and the like. Names and titles for persons to whom the statement should be attributed should be supplied. It is desirable to print and revise such statements prior to making them. Therefore, proposed statements may be sent to various designated teams members for review and marked appropriately to indicate they are only proposed and not final versions. General guidelines for various requirements may be provided for reference as indicated at, such as media guide line 134. For example tips may include remaining calm to thereby keep the media audience calm. Other tips may include discussing issues of interest to the media audience and avoiding, where possible, excessive technical jargon.

Various emergency priorities may be listed for reference in making decisions as indicated at 136, 138, and 140. For instance, very generally, human life is first priority, property is priority two, and business interruption issues are priority three. More specific details will preferably be provided to provide immediate reference.

The present invention may also include means for setting up and maintaining procedures. For instance, a meeting organization scheduler 142 and 143 may be provided for scheduling meetings in accord with the present invention including meeting formats/goals and the like. In one embodiment, the meeting scheduler 142 may be used to set up, maintain, and track changes to reporting tree or network 10 as indicated at 144. As well, crisis organization setup meeting formats may be provided to organize meetings to produce network 10, designate team members, set up priority communication lines, and the like are provided in module 146 of computer program 100. This module may also include logs and notes of such meetings. Regular training meeting formats and refresher courses may also be outlined and scheduled as indicated at 148. Prepared formats of meetings are useful in quickly and easily organizing such meetings to thereby efficiently reach the desired goals of developing an effective crisis response. Database 150 may be used to provide a central storage of the latest information which can be accessed by all locations. Since program 100 may be utilized in many computers simultaneously, it may be desirable to provide means for communicating with and updating all computers as desired. Other means for centralizing computer operation could also be used such as with servers, online databases, and the like.

In summary, the present invention has been found to provide an effective method and system for handling crisis that may arise. The foregoing disclosure and description of the invention is illustrative and explanatory thereof, and it will be appreciated by those skilled in the art, that various changes in the size, shape and materials, the use of mechanical equivalents, as well as in the details of the illustrated construction or combinations of features of the various elements may be made without departing from the spirit of the invention.

What is claimed is:

1. A method for crisis control for a plurality of organization members in a non-emergency organization, said method comprising:
preparing a crisis communication reporting tree with designated sections of said non-emergency organization to be notified;
providing said crisis communication reporting tree with designated sections for external sections which are not part of said non-emergency organization;
providing said communications reporting network with priority flow paths, said priority flow paths indicating a desired path of communication between said organization sections and a priority for contacting each said organization section; and
providing that each organization member is provided with at least two previously designated contacts within said crisis communication reporting tree for originating a crisis report by at least one type of communication means.

2. The method of claim 1, wherein said external sections which are not part of said non-emergency organization include emergency organizations and media.

3. The method of claim 1, further comprising:
providing said communications reporting tree with priority flow paths whereby alerts for all crisis and alert on an as needed basis are designated.

4. The method of claim 1, further comprising:
providing different communication flow paths depending on a type of communication to be utilized.

5. The method of claim 1, further comprising:
limiting telephone calls from a first crisis reporter to no more or less than two call contacts to be reached wherein said first crisis reporter is one of said plurality of organization members.

6. The method of claim 1, further comprising:
providing a crisis control computer program operable on a plurality of computers for access by said plurality of organization members.

7. The method of claim 6, further comprising:
providing a plurality of forms related to responding to a crisis within said crisis control computer program.

8. The method of claim 7, further comprising:
providing one or more previously prepared communication lists for sending one or more of said forms within said crisis control computer program.

9. The method of claim 8, wherein said one or more previously prepared communication lists includes an email group.

10. The method of claim 8, wherein said one or more previously prepared communication lists includes a facsimile group.

11. The method of claim 6, further comprising:
providing a telephone listing for calls related to a particular computer station in said crisis control computer program.

12. The method of claim 6, further comprising:
providing step by step procedures in said crisis control computer program.

13. The method of claim 6, further comprising:
displaying an emergency button on each of a plurality computer screens for starting said crisis control computer program by a respective organization member.

14. A program storage device readable by a machine, embodying a program of instructions executable by the machine to perform method steps for crisis control, the method comprising:
providing a predetermined crisis communication reporting network for reporting a crisis to designated sections of said non-emergency organization;
providing said crisis communication reporting network with designated sections for external sections which are not part of said non-emergency organization;
providing said communications reporting network with priority flow paths, said priority flow paths indicating a desired path of communication between said organization sections and a priority for contacting each said organization section; and
providing that each organization member has at least two previously designated contacts for originating a crisis report by at least one type of communication means.

15. The method of claim 14, wherein said external sections which are not part of said non-emergency organization include emergency organizations.

16. The method of claim 14, wherein said external sections which are not part of said non-emergency organization include media organizations.

17. The method of claim 14, further comprising:
limiting telephone calls from a first crisis reporter to no more and no less than two call contacts to be reached if said first crisis reporter is one of said plurality of organization members who is first to notify said non-emergency organization of said crisis.

18. The method of claim 14, further comprising:
providing different communication guidelines depending on a type of communication to be utilized.

19. The method of claim 14, further comprising:
selectively displaying a plurality of forms related to responding to a crisis within said crisis control computer program.

20. The method of claim 19, further comprising:
selectively utilizing one or more previously prepared communication lists for sending one or more of said forms.

21. The method of claim 20, wherein said one or more previously prepared communication lists includes an email group.

22. The method of claim 20, wherein said one or more previously prepared communication lists includes a facsimile group.

23. The method of claim 14, further comprising:
selectively displaying a telephone listing for calls related to a particular computer station in said organization.

24. The method of claim 14, further comprising:
selectively displaying step by step crisis control procedures on each of a plurality of computers.

25. The method of claim 14, further comprising:
displaying a quick start crisis program start figure on each of a plurality of computer computers in said organization.
